(19) United States
(12) Patent Application Publication
(10) Pub. No.: US 2026/0031542 A1
(43) Pub. Date: Jan. 29, 2026

(54) ANTENNA DEVICE AND COMMUNICATION DEVICE INCLUDING SAME

(71) Applicant: Murata Manufacturing Co., Ltd., Nagaokakyo-shi (JP)

(72) Inventors: Kaoru SUDO, Nagaokakyo-shi (JP); Yosuke SATO, Nagaokakyo-shi (JP)

(73) Assignee: Murata Manufacturing Co., Ltd., Nagaokakyo-shi (JP)

(21) Appl. No.: 19/348,824

(22) Filed: Oct. 3, 2025

Related U.S. Application Data
(63) Continuation of application No. PCT/JP2024/020144, filed on Jun. 3, 2024.

(30) Foreign Application Priority Data
Jul. 19, 2023 (JP) 2023-117736

(51) Int. Cl. H01Q 9/04

(52) U.S. Cl. CPC H01Q 9/0485

(57) ABSTRACT

An antenna device includes a first substrate and a second substrate. The first substrate includes a ground electrode having a flat plate-like shape, a radiating element having a flat plate-like shape, and a peripheral electrode electrically connected to the ground electrode. The second substrate includes a first main surface facing the first substrate, a second main surface) opposite to the first main surface, a ground electrode disposed on or in the second main surface), and a ground pad disposed on or in the first main surface). The peripheral electrode and the ground pad are connected to each other.

### CROSS-REFERENCE TO RELATED APPLICATIONS

The present application is a bypass continuation of International Application No. PCT/JP2024/020144, filed Jun. 3, 2024, which claims priority to Japanese patent application JP 2023-117736, filed Jul. 19, 2023, the entire contents of each of which being incorporated herein by reference.

### TECHNICAL FIELD

The present disclosure relates to an antenna device and a communication device including the antenna device.

### BACKGROUND ART

International Publication No. 2021/059661 (Patent Document 1) discloses a configuration in which a peripheral electrode connected to a ground electrode having a flat plate-like shape is disposed on or in a side surface of a substrate in which the ground electrode and a radiating element (patch antenna) having a flat plate-like shape are arranged to face each other.

### CITATION LIST

### Patent Document

Patent Document 1: International Publication No. 2021/059661

### SUMMARY

### Technical Problems

With the configuration disclosed in International Publication No. 2021/059661 (Patent Document 1), although radio waves can be radiated from the radiating element in a direction normal to the substrate, it is not possible to radiate radio waves in a direction intersecting the direction normal to the substrate.

The present disclosure has been made to solve such a problem described above and others, and is directed to providing an antenna device capable of radiating radio waves in a direction intersecting a direction normal to a substrate.

### Solutions to Problems

An antenna device according to an aspect of the present disclosure includes a first substrate and a second substrate having a first main surface facing the first substrate and a second main surface opposite to the first main surface. The first substrate includes a first ground electrode having a flat plate-like shape and a radiating element having a flat plate-like shape, the first ground electrode and the radiating element being arranged to face each other in a direction intersecting a direction normal to the second substrate, and a peripheral electrode disposed on or in an opposing surface being a surface facing the second substrate, the peripheral electrode being electrically connected to the first ground electrode. The second substrate includes a second ground electrode disposed on or in the second main surface or between the second main surface and the first main surface, the second ground electrode having a flat plate-like shape and extending along the second main surface, and a ground pad disposed on or in the first main surface and electrically connected to the second ground electrode. The peripheral electrode and the ground pad are connected to each other through a connecting member having electrical conductivity.

### Advantageous Effects

According to the present disclosure, it is possible to provide an antenna device capable of radiating radio waves in a direction intersecting a direction normal to a substrate (second substrate).

### BRIEF DESCRIPTION OF DRAWINGS

FIG. 1 is an example of a block diagram of a communication device to which an antenna device is applied.

FIG. 2 is a diagram (part 1) partially illustrating the periphery of one of radiating elements in the antenna device.

FIG. 3 is a diagram (part 2) partially illustrating the periphery of one of the radiating elements in an antenna device.

FIG. 4 is a plan view of a first substrate of an antenna device.

FIG. 5 is a diagram (part 3) partially illustrating the periphery of one of the radiating elements in an antenna device.

FIG. 6 is a cross-sectional view taken along line VI-VI in FIG. 5(C).

FIG. 7 is a cross-sectional view taken along the line VII-VII in FIG. 5(C).

FIG. 8 is a diagram (part 4) partially illustrating the periphery of one of the radiating elements in an antenna device.

### DESCRIPTION OF EMBODIMENTS

Embodiments of the present disclosure will be described in detail below with reference to the accompanying drawings. In the drawings, the same or corresponding components are denoted by the same reference signs, and descriptions thereof will not be repeated.

### (Basic Configuration of Communication Device)

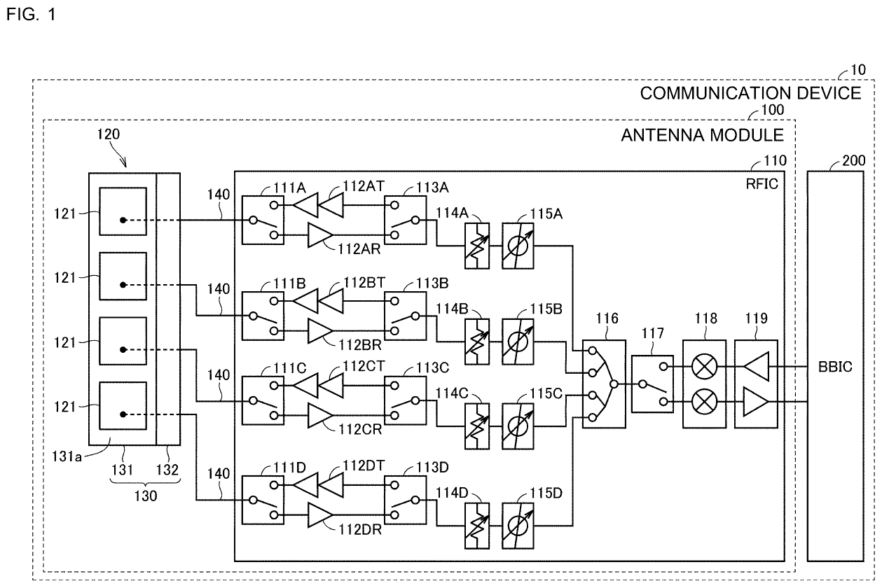

FIG. 1 is an example of a block diagram of a communication device 10 to which an antenna device 120 according to the present embodiment is applied. The communication device 10 is, for example, a mobile terminal such as a cellular phone, a smartphone, or a tablet, or a personal computer equipped with communication functionality. One example of a frequency band of radio waves used in the antenna device 120 according to the present embodiment is a millimeter-wave band having a center frequency of, for example, 28 GHZ, 39 GHz, or 60 GHz. However, the present disclosure is also applicable to radio waves in frequency bands other than those mentioned above.

Referring to FIG. 1, the communication device 10 includes an antenna module 100 and a BBIC 200 that forms a baseband signal processing circuit. The antenna module 100 includes an RFIC 110, which is one example of a power feeding device, and the antenna device 120. The communication device 10 up-converts an intermediate-frequency signal that has been transmitted from the BBIC 200 to the antenna module 100 into a radio frequency signal, and radiates the radio frequency signal from the antenna device 120. In addition, the communication device 10 down-converts a radio frequency signal received by the antenna device 120 into an intermediate frequency signal, and processes the intermediate frequency signal using the BBIC 200.

The antenna device 120 includes a dielectric substrate 130 where a plurality of radiating elements 121 are arranged. The dielectric substrate 130 includes a first substrate 131 and a second substrate 132, and the plurality of radiating elements 121 are arranged on or in a mounting surface 131a of the first substrate 131.

FIG. 1 illustrates an example of an array configuration in which the four radiating elements 121 are arranged in a line. However, the number of the radiating elements 121 and their arrangement are not limited to those in this example. The number of the radiating elements 121 disposed on or in the mounting surface 131a of the first substrate 131 may be one or may be five or more. Alternatively, an array configuration in which the radiating elements 121 are arranged in a two-dimensional manner may be employed.

The first substrate 131 and the second substrate 132 included in the dielectric substrate 130 may each be, for example, a low temperature co-fired ceramics (LTCC) multilayer substrate, a multilayer resin substrate formed by stacking a plurality of resin layers each made of a resin such as epoxy or polyimide, a multilayer resin substrate formed by stacking a plurality of resin layers each made of a liquid crystal polymer (LCP) having a lower dielectric constant, a multilayer resin substrate formed by stacking a plurality of resin layers each made of a fluororesin, a multilayer resin substrate formed by stacking a plurality of resin layers each made of a polyethylene terephthalate (PET) material, or a ceramic multilayer substrate made of a ceramic other than LTCC. Note that each of the first substrate 131 and the second substrate 132 does not need to have a multilayer structure, and each may be a single-layer substrate. In addition, the first substrate 131 and the second substrate 132 may be formed of the same dielectric material or may be formed of different dielectric materials.

Each of the radiating elements 121 is a patch antenna having a flat plate-like shape. In the present embodiment, a case where each of the radiating elements 121 is a microstrip antenna having a substantially square shape will be described as an example.

In the antenna module 100 according to the present embodiment, radio frequency signals are fed to the radiating elements 121 from respective feed wiring lines 140. The antenna module 100 is a so-called single-band, single-polarized antenna module.

The RFIC 110 includes switches 111A to 111D, 113A to 113D, and 117, power amplifiers 112AT to 112DT, low-noise amplifiers 112AR to 112DR, attenuators 114A to 114D, phase shifters 115A to 115D, a signal combiner/divider 116, a mixer 118, and an amplifier circuit 119.

When transmitting a radio frequency signal, the switches 111A to 111D and 113A to 113D are switched to the side on which the power amplifiers 112AT to 112DT are provided, and the switch 117 is connected to a transmission-side amplifier of the amplifier circuit 119. When receiving a radio frequency signal, the switches 111A to 111D and 113A to 113D are switched to the side on which the low-noise amplifiers 112AR to 112DR are provided, and the switch 117 is connected to a reception-side amplifier of the amplifier circuit 119.

An intermediate-frequency signal transmitted from the BBIC 200 is amplified by the amplifier circuit 119 and up-converted by the mixer 118. A transmission signal, which is an up-converted radio frequency signal, is divided into four branches by the signal combiner/divider 116, passes through corresponding signal paths, and is fed to the respective radiating elements 121. By individually adjusting the degrees of phase shift of the phase shifters 115A to 115D disposed in or on the respective signal paths, the directivity of the radio waves emitted from the radiating elements 121 can be adjusted. In addition, the attenuators 114A to 114D adjust the power level of the transmission signal.

Received signals, which are radio frequency signals received by the respective radiating elements 121, are transmitted to the RFIC 110, pass through four different signal paths, and are combined together by the signal combiner/divider 116. The combined received signal is down-converted into an intermediate-frequency signal by the mixer 118 and further amplified by the amplifier circuit 119. Then, it is transmitted to the BBIC 200.

The RFIC 110 is formed, for example, as a one-chip integrated circuit component. Alternatively, the devices (switches, power amplifiers, low-noise amplifiers, attenuators, and phase shifters) corresponding to the respective radiating elements may be formed, for each corresponding radiating element, as a one-chip integrated circuit component. The RFIC 110 may be mounted on or in the second substrate 132 of the antenna device 120.

### (Structure of Antenna Device 120)

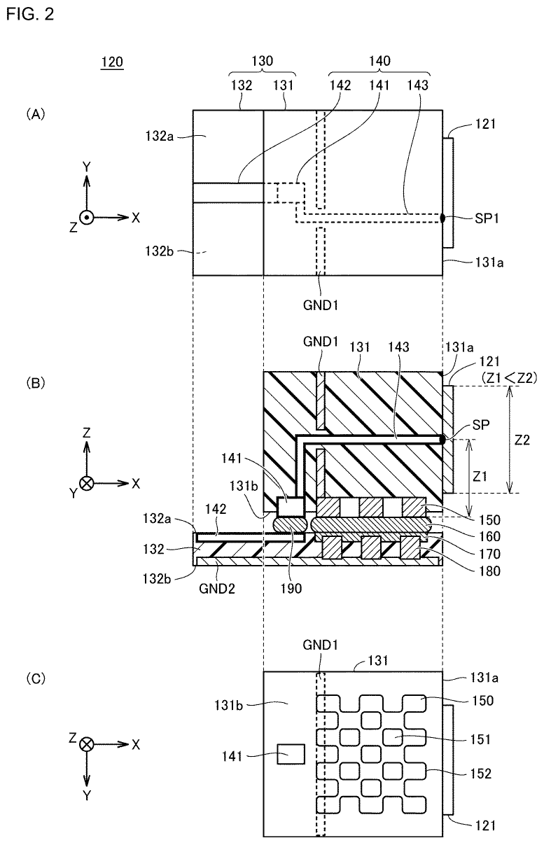

Next, the detailed configuration of the antenna device 120 will be described with reference to FIG. 2. FIG. 2 is a diagram partially illustrating the periphery of one of the radiating elements 121 in the antenna device 120. In FIG. 2, a plan view (FIG. 2(A)) of the antenna device 120 is illustrated in the upper part, a side perspective view (FIG. 2(B)) of the antenna device 120 is illustrated in the middle part, and a plan view (FIG. 2(C)) of the first substrate 131 when viewed from a negative Z-axis direction is illustrated in the lower part.

As described above, the dielectric substrate 130 includes the first substrate 131, configured as a dielectric body or block, and the second substrate 132, and the radiating elements 121 are arranged on or in the mounting surface 131a of the first substrate 131 and the second substrate 132 may be a primary substrate that serves as a main board on which remaining antenna structure is built.

The first substrate 131 has the mounting surface 131a, on or in which the radiating elements 121 are arranged, and an opposing surface 131b that faces the second substrate 132. The mounting surface 131a and the opposing surface 131b are substantially perpendicular to each other.

The second substrate 132 has a first main surface 132a facing the first substrate 131 and a second main surface 132b opposite to the first main surface 132a. The first main surface 132a of the second substrate 132 and the mounting surface 131a of the first substrate 131 are substantially perpendicular to each other. In other words, a direction normal to the second substrate 132 and a direction normal to each of the radiating elements 121 are substantially orthogonal to each other.

In the following description, the direction normal to the second substrate 132 is defined as the Z-axis direction, and the direction normal to each of the radiating elements 121 is defined as the X-axis direction. A direction orthogonal to both the Z-axis direction and the X-axis direction is defined as the Y-axis direction. In addition, the positive Z-axis direction and the negative Z-axis direction in the drawings may sometimes be referred to as the upper side and the lower side, respectively.

The first substrate 131 includes, in addition to the radiating elements 121, a ground electrode GND1 having a flat plate-like shape and a peripheral electrode 150. The ground electrode GND1 is disposed at a position spaced apart from the radiating elements 121 by a predetermined distance in the X-axis direction, in such a manner as to face the radiating elements 121. Note that, in FIG. 2, the radiating elements 121 are arranged so as to be exposed at the mounting surface 131a of the first substrate 131. However, the radiating elements 121 may be arranged inside the first substrate 131 (between the mounting surface 131a and the ground electrode GND1). In the present embodiment, the first substrate 131 is a multilayer body having a lamination direction parallel to the direction normal to each of the radiating elements 121 (X-axis direction).

The peripheral electrode 150 is disposed on or in the opposing surface 131b of the first substrate 131, at a position between the ground electrode GND1 and the radiating elements 121. The peripheral electrode 150 is electrically connected to the ground electrode GND1. When the first substrate 131 is viewed from the X-axis direction, a distance Z1 from the center of a surface of each of the radiating elements 121 to an end portion of the peripheral electrode 150 is smaller than a dimension Z2 of each of the radiating elements 121 in the Z-axis direction.

In addition, the peripheral electrode 150 is disposed in such a manner as to be exposed at the opposing surface 131b of the first substrate 131. As a result, the peripheral electrode 150 also functions as a ground pad of the first substrate 131.

The second substrate 132 includes a ground electrode GND2 having a flat plate-like shape and a ground pad 170. The ground electrode GND2 is disposed on or in the second main surface 132b of the second substrate 132, extending over the entire surface of the second main surface 132b. Note that the ground electrode GND2 may be disposed in an intermediate layer of the second substrate 132 (between the second main surface 132b and the first main surface 132a). In the present embodiment, the second substrate 132 is a multilayer body having a lamination direction parallel to the direction normal to the first main surface 132a (Z-axis direction).

The ground pad 170 is disposed on or in the first main surface 132a of the second substrate 132 and connected to the ground electrode GND2 through a via 180. More specifically, the ground pad 170 is disposed on or in the first main surface 132a of the second substrate 132, at a position facing the peripheral electrode 150. The peripheral electrode 150 and the ground pad 170 are connected to each other through a solder paste 160 while the peripheral electrode 150 and the ground pad 170 face each other. Note that the peripheral electrode 150 and the ground pad 170 are not necessarily limited to being connected to each other by soldering, as long as they are electrically connected to each other through a connecting member having electrical conductivity. For example, the peripheral electrode 150 and the ground pad 170 may be connected to each other by using a multipolar connector instead of a solder connection.

As illustrated in the lower part of FIG. 2 (FIG. 2(C)), when the peripheral electrode 150 is viewed from the negative Z-axis direction, the peripheral electrode 150 is a single electrode as a whole and includes gap portions 151 within a region enclosed by an outer edge 152 thereof. Each of the gap portions 151 has a substantially rectangular shape, and no electrodes are formed in or on the gap portions 151. In particular, the peripheral electrode 150 according to the present embodiment has a lattice shape in which portions in or on which electrodes are formed and the gap portions 151 in or on which no electrodes are formed are alternately arranged.

The feed wiring lines 140 are arranged in such a manner as to extend across the first substrate 131 and the second substrate 132. More specifically, each of the feed wiring lines 140 includes a first signal pad 141, a second signal pad 142, a feed line 143, and a solder paste 190.

Each of the first signal pads 141 is disposed on or in the opposing surface 131b of the first substrate 131. More specifically, the first signal pads 141 are arranged on or in the opposing surface 131b of the first substrate 131, in a region located on the side opposite to the side on which the peripheral electrode 150 is disposed, with the ground electrode GND1 interposed between the first signal pads 141 and the peripheral electrode 150.

Each of the second signal pads 142 is disposed on or in the first main surface 132a of the second substrate 132 and connected to the first signal pads 141 of the first substrate 131 through the corresponding solder paste 190. The feed lines 143 extend within the first substrate 131 and connect the first signal pads 141 to respective feed points SP1 of the radiating elements 121.

Radio frequency signals are fed from the RFIC 110 (see FIG. 1) to the feed points SP1 of the radiating elements 121 through the respective feed wiring lines 140. Each of the feed points SP1 is offset in the negative Y-axis direction from the center of the corresponding radiating element 121. As a result, radio waves polarized in the Y-axis direction are radiated from the radiating elements 121 in the X-axis direction.

The peripheral electrode 150 is connected to the ground electrode GND1 and connected to the ground pad 170 of the second substrate 132 through the solder paste 160 while the peripheral electrode 150 faces the ground pad 170. The ground pad 170 is connected to the ground electrode GND2 through the via 180. Accordingly, the electric potential of the peripheral electrode 150 is at a ground potential.

For example, when the area of the ground electrode GND1 is limited due to the demand for miniaturization, a portion of the electric field between the radiating elements 121 and the ground electrode GND1 may be generated so as to extend around to the rear surface side of the ground electrode GND1. Due to the generation of such an electric field, radio waves become less likely to be radiated from the radiating elements 121 compared with the case where the area of the ground electrode GND1 is sufficiently large, which may result in degradation of antenna characteristics.

However, in the antenna device 120 according to the present embodiment, the peripheral electrode 150 is disposed on or in the opposing surface 131b of the first substrate 131, at a position between the radiating elements 121 and the ground electrode GND1. With such an arrangement of the peripheral electrode 150, electric field lines may be generated between the radiating elements 121 and the peripheral electrode 150, and thus, generation of an electric field that extends around to the rear surface side of the ground electrode GND1 is suppressed. Therefore, even in the case where the area of the ground electrode GND1 is limited due to the demand for miniaturization, degradation of the antenna characteristics can be suppressed.

In addition, in the antenna device 120 according to the present embodiment, the direction normal to the radiating elements 121 (X-axis direction) is substantially orthogonal to the direction normal to the second substrate 132 (Z-axis direction). Therefore, radio waves can be radiated from the radiating elements 121 in the direction (X-axis direction) that is substantially orthogonal to the direction normal to the second substrate 132 (Z-axis direction).

Furthermore, in the antenna device 120 according to the present embodiment, the peripheral electrode 150 of the first substrate 131 is connected to the ground pad 170 of the second substrate 132 through the solder paste 160. As a result, not only the peripheral electrode 150, but also the solder paste 160 and the ground pad 170 that are adjacent to the peripheral electrode 150 in the Z-axis direction are at the ground potential, and electric field lines may be generated between these entire portions and the radiating elements 121. Therefore, compared with the case where only the peripheral electrode 150 exists alone, the dimension in the Z-axis direction of a portion that functions as a peripheral electrode can be substantially increased. As a result, the electric field coupling between each of the radiating elements 121 and the peripheral electrode 150 can be further enhanced, and the antenna gain can be improved.

In the antenna device 120 according to the present embodiment, when the peripheral electrode 150 is viewed from the Z-axis direction, the peripheral electrode 150 is a single electrode as a whole and has the lattice shape in which the portions in or on which electrodes are formed and the gap portions 151 in or on which no electrodes are formed are alternately arranged. By forming the peripheral electrode 150 in a lattice shape in this manner, an increase in the volume of the peripheral electrode 150 can be suppressed compared with the case where the peripheral electrode 150 has a simple flat plate-like shape. As a result, the cost of the antenna device 120 can be reduced.

In addition, by forming the peripheral electrode 150 in a lattice shape, it becomes easier to adjust the electric field coupling between the radiating elements 121 and the peripheral electrode 150, while ensuring the mounting strength of the first substrate 131 to the second substrate 132. For example, in the case where the electric field coupling between the radiating elements 121 and the peripheral electrode 150 is excessive, the antenna gain may sometimes deteriorate. Consequently, it is desirable to reduce the electric field coupling between the radiating elements 121 and the peripheral electrode 150. As a method of reducing the electric field coupling between the radiating elements 121 and the peripheral electrode 150, increasing the distance between each of the radiating elements 121 and the peripheral electrode 150 in the X-axis direction may be considered. However, increasing the distance between each of the radiating elements 121 and the peripheral electrode 150 in the X-axis direction causes the peripheral electrode 150 to be shifted toward the ground electrode GND1 on or in the opposing surface 131b of the first substrate 131, and thus, there is a concern that the mounting strength of the first substrate 131 to the second substrate 132 may be reduced. In contrast, in the antenna device 120 according to the present embodiment, since the peripheral electrode 150 has a lattice shape, the volume of the peripheral electrode 150 can be reduced so as to reduce the electric field coupling between the radiating elements 121 and the peripheral electrode 150, while suppressing the peripheral electrode 150 from being shifted toward the ground electrode GND1 on or in the opposing surface 131b of the first substrate 131, thereby ensuring the mounting strength of the first substrate 131 to the second substrate 132.

In addition, in the case where the first signal pads 141 and the peripheral electrode 150 are formed using a paste, forming the peripheral electrode 150 in a lattice shape makes it easier to suppress an imbalance between the thickness (i.e., dimension in the Z-axis direction) of the paste forming each of the first signal pads 141 and the thickness (i.e., dimension in the Z-axis direction) of the paste forming the peripheral electrode 150. In other words, although the first signal pads 141 and the peripheral electrode 150 are located at the same layer in the Z-axis direction, if there is a large difference between the area of each of the first signal pads 141 and the area of the peripheral electrode 150 when viewed from the Z-axis direction, there is a concern that the thickness of the paste forming each of the first signal pads 141 may become thick, whereas the thickness of the paste forming the peripheral electrode 150 may become thin. In contrast, in the antenna device 120 according to the present embodiment, since the peripheral electrode 150 has a lattice shape, each of the areas of the electrode-continuous portions of the peripheral electrode 150 can be made close to the area of each of the first signal pads 141. This makes it easier to suppress an imbalance between the thickness of the paste forming each of the first signal pads 141 and the thickness of the paste forming the peripheral electrode 150 compared with the case where the peripheral electrode 150 has a simple flat plate-like shape.

In addition, in the antenna device 120 according to the present embodiment, the first signal pads 141 are arranged on or in the opposing surface 131b of the first substrate 131, in the region located on the side opposite to the side on which the peripheral electrode 150 is disposed, with the ground electrode GND1 interposed between the first signal pads 141 and the peripheral electrode 150. This facilitates impedance matching of the feed wiring lines 140. In other words, if the first signal pads 141 are arranged on or in the opposing surface 131b, in a region between the ground electrode GND1 and the radiating elements 121 (i.e., in the same region as the peripheral electrode 150 as seen from the ground electrode GND1), it will be difficult to maintain a constant distance between each of the first signal pads 141, through which radio frequency signals pass, and the peripheral electrode 150, which is at the ground potential, making it difficult to achieve impedance matching of the feed wiring lines 140. In contrast, in the antenna device 120 according to the present embodiment, since the ground electrode GND1 is disposed between the first signal pads 141 and the peripheral electrode 150, impedance matching of the feed wiring lines 140 can be achieved by maintaining a constant distance between each of the first signal pads 141 and the ground electrode GND1. As a result, impedance matching of the feed wiring lines 140 is facilitated.

In the antenna device 120 according to the present embodiment, the first substrate 131 is a multilayer body having a lamination direction parallel to the direction normal to each of the radiating elements 121 (X-axis direction). Accordingly, each of the radiating elements 121 can be formed by using a standard electrode pattern rather than a via. Consequently, compared with the case where each of the radiating elements 121 is formed by using a via, variations in the characteristics of radio waves radiated from the radiating elements 121 can be suppressed.

The “communication device 10” and the “antenna device 120” according to the present embodiment may correspond to a “communication device” and an “antenna device” according to the present disclosure, respectively.

The “first substrate 131”, the “opposing surface 131b”, and the “ground electrode GND1” according to the present embodiment may correspond to a “first substrate”, an “opposing surface”, and a “first ground electrode”, according to the present disclosure, respectively. The “radiating elements 121” according to the present embodiment may each correspond to a “radiating element” according to the present disclosure.

The “peripheral electrode 150” according to the present embodiment may correspond to a “peripheral electrode” according to the present disclosure, and the “gap portions 151” according to the present embodiment may each correspond to a “gap portion” according to the present disclosure.

The “solder paste 160” according to the present embodiment may correspond to a “connecting member having electrical conductivity” according to the present disclosure.

The “feed wiring lines 140” according to the present embodiment may each correspond to a “first feed wiring line” according to the present disclosure. The “first signal pads 141” according to the present embodiment may each correspond to a “first signal pad” according to the present disclosure. The “second signal pads 142” according to the present embodiment may each correspond to a “second signal pad” according to the present disclosure.

### <Modification 1>

In the above-described embodiment, although the first substrate 131 is a multilayer body having a lamination direction parallel to the direction normal to each of the radiating elements 121 (X-axis direction), the first substrate 131 may be a multilayer body having a lamination direction parallel to the direction normal to the second substrate 132 (Z-axis direction). With this configuration, the peripheral electrode 150 can be formed by using a standard electrode pattern rather than a via. As a result, compared with the case where the peripheral electrode 150 is formed by using a via, variations in the characteristics as the peripheral electrode 150 can be suppressed.

### <Modification 2>

Although the antenna device 120 according to the above-described embodiment is a so-called single-band, single-polarized antenna, the antenna device 120 may be an antenna that supports dual polarization or dual band.

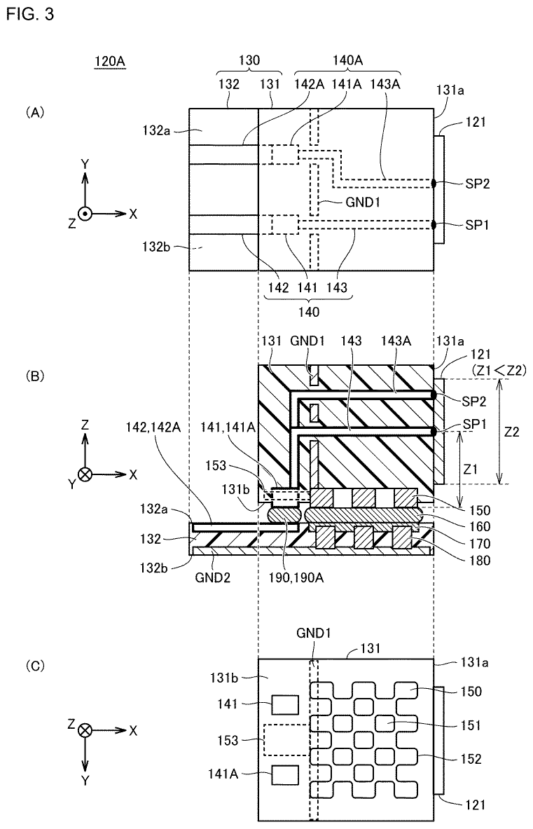

FIG. 3 is a diagram partially illustrating the periphery of one of the radiating elements 121 in an antenna device 120A according to Modification 2. The antenna device 120A is a so-called dual-polarized antenna. In FIG. 3, a plan view (FIG. 3(A)) of the antenna device 120A is illustrated in the upper part, a side perspective view (FIG. 3(B)) of the antenna device 120A is illustrated in the middle part, and a plan view (FIG. 3(C)) of the first substrate 131 of the antenna device 120A is illustrated in the lower part.

The antenna device 120A according to Modification 2 is obtained by adding feed wiring lines 140A to the above-described antenna device 120. In other words, the antenna device 120A according to Modification 2 includes the two feed wiring lines 140 and 140A.

As described above, each of the feed wiring lines 140 is disposed in such a manner as to extend across the first substrate 131 and the second substrate 132 and includes the first signal pad 141, the second signal pad 142, the feed line 143, and the solder paste 190. The feed wiring lines 140 connect the RFIC 110 to the respective feed points SP1 of the radiating elements 121. Note that, as described above, each of the feed points SP1 is offset in the negative Y-axis direction from the center of the corresponding radiating element 121. Accordingly, when radio frequency signals from the feed wiring lines 140 are fed to the respective feed points SP1 of the radiating elements 121, radio waves polarized in the Y-axis direction are radiated from the radiating elements 121 in the X-axis direction.

Each of the feed wiring lines 140A has a configuration similar to that of each of the feed wiring lines 140. More specifically, each of the feed wiring lines 140A is disposed in such a manner as to extend across the first substrate 131 and the second substrate 132 and includes a third signal pad 141A, a fourth signal pad 142A, a feed line 143A, and a solder paste 190A. The third signal pads 141A are arranged on or in the opposing surface 131b of the first substrate 131, in a region located on the side opposite to the side on which the peripheral electrode 150 is disposed, with the ground electrode GND1 interposed between the third signal pads 141A and the peripheral electrode 150. The feed wiring lines 140A connect the RFIC 110 to respective feed points SP2 of the radiating elements 121. Note that each of the feed points SP2 is offset in the positive Z-axis direction from the center of the corresponding radiating element 121. Accordingly, when radio frequency signals from the feed wiring lines 140A are fed to the respective feed points SP2 of the radiating elements 121, radio waves polarized in the Z-axis direction are radiated from the radiating elements 121 in the X-axis direction.

With this configuration, the antenna device 120A can function as an antenna that supports dual polarization.

In addition, each of the first signal pads 141 for the feed wiring lines 140 and a respective one of the third signal pads 141A for the feed wiring lines 140A are arranged in the Y-axis direction on or in the opposing surface 131b of the first substrate 131.

In addition, when viewed from the Z-axis direction (the direction normal to the second substrate 132), a grounding member 153 that is connected to the peripheral electrode 150 is disposed in a region between each of the first signal pads 141 and a respective one of the third signal pads 141A. As a result, isolation between the first signal pads 141 and their respective third signal pads 141A can be ensured.

Note that, although the antenna device 120A illustrated in FIG. 2 is a dual-polarized antenna, the antenna device may be an antenna that supports dual band. In this case, for example, on or in the first substrate 131, additional radiating elements each having a size different from that of each of the radiating elements 121 may be provided between the radiating elements 121 and the ground electrode GND1, and the feed wiring lines 140A may be connected to respective feed points of these additional radiating elements.

The “feed wiring lines 140A” according to Modification 2 may each correspond to a “second feed wiring line” according to the present disclosure. The “third signal pads 141A” according to Modification 2 may each correspond to a “third signal pad” according to the present disclosure. The “fourth signal pads 142A” according to Modification 2 may each correspond to a “fourth signal pad” according to the present disclosure.

### <Modification 3>

Although the peripheral electrode 150 according to the above-described embodiment has a lattice shape in which the portions in or on which electrodes are formed and the gap portions 151 in or on which no electrodes are formed are alternately arranged, the peripheral electrode 150 is not necessarily limited to the lattice shape.

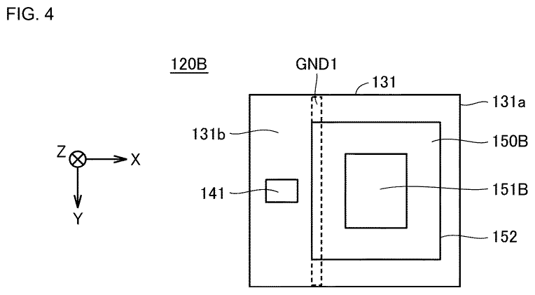

FIG. 4 is a plan view of the first substrate 131 of an antenna device 120B according to Modification 3 when viewed from the negative Z-axis direction. When a peripheral electrode 150B that is included in the antenna device 120B is viewed from the negative Z-axis direction, the peripheral electrode 150B is a single electrode as a whole and includes a relatively large single gap portion 151B within a region enclosed by the outer edge 152 of the peripheral electrode 150B. Even in the case where the peripheral electrode 150B has such a shape, the volume of the peripheral electrode 150B can be reduced so as to reduce the electric field coupling between the radiating elements 121 and the peripheral electrode 150B, while suppressing the peripheral electrode 150B from being shifted toward the ground electrode GND1 on or in the opposing surface 131b of the first substrate 131, thereby ensuring the mounting strength of the first substrate 131 to the second substrate 132.

The “peripheral electrode 150B” and the “gap portion 151B” according to Modification 3 may correspond to the “peripheral electrode” and the “gap portion” according to the present disclosure, respectively.

### <Modification 4>

The peripheral electrode 150 and the first signal pads 141 according to the above-described embodiment may be constituted by columnar conductors each having a semicircular cross section.

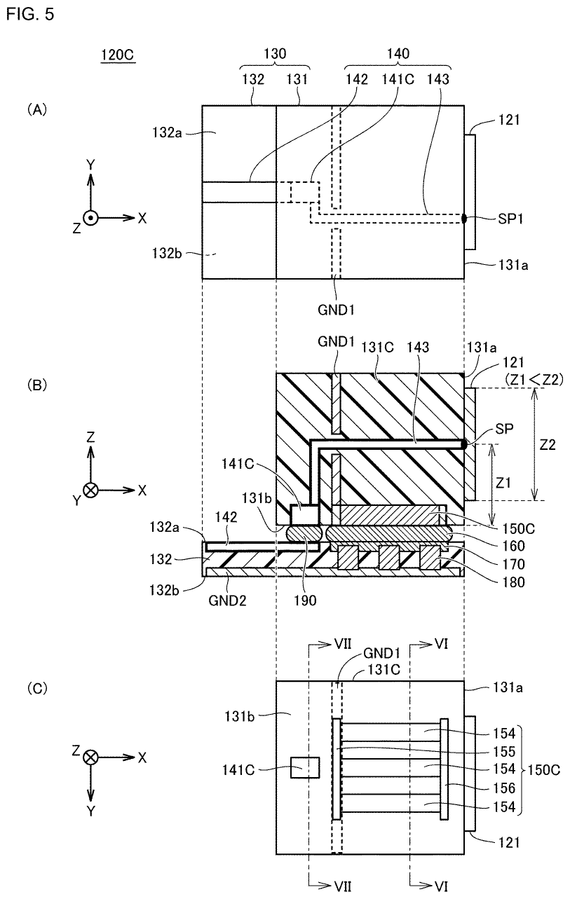

FIG. 5 is a diagram partially illustrating the periphery of one of the radiating elements 121 in an antenna device 120C according to Modification 4. In FIG. 5, a plan view (FIG. 5(A)) of the antenna device 120C is illustrated in the upper part, a side perspective view (FIG. 5(B)) of the antenna device 120C is illustrated in the middle part, and a plan view (FIG. 5(C)) of the first substrate 131 of the antenna device 120C is illustrated in the lower part.

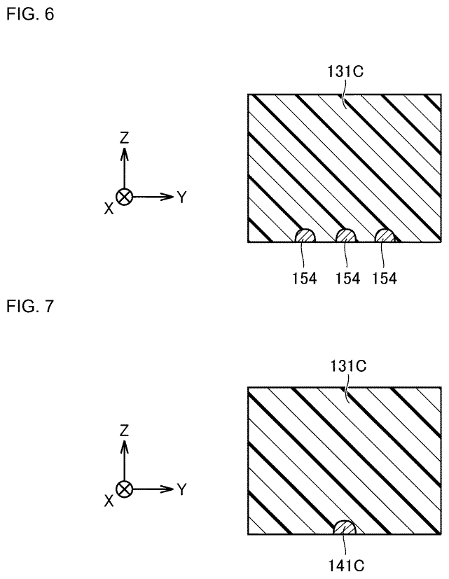

FIG. 6 is a cross-sectional view taken along line VI-VI in FIG. 5(C). FIG. 7 is a cross-sectional view taken along the line VII-VII in FIG. 5(C).

The antenna device 120C according to Modification 4 is obtained by changing the first substrate 131 of the above-described antenna device 120 to a first substrate 131C. The first substrate 131C is obtained by changing the peripheral electrode 150 and the first signal pads 141, which are arranged on or in the above-described first substrate 131, to a peripheral electrode 150C and first signal pads 141C, respectively.

The peripheral electrode 150C includes a plurality (three in FIG. 5) of conductors 154, a conductor 155, and a conductor 156. Each of the plurality of conductors 154 extends in the X-axis direction. The conductor 155 connects the end surfaces of the plurality of conductors 154 in the negative X-axis direction to one another. The conductor 156 connects the end surfaces of the plurality of conductors 154 in the positive X-axis direction to one another. Each of the conductors 154 is a columnar conductor having a semicircular cross section (see FIG. 6). Each of the conductors 154 may be formed, for example, by splitting a columnar via in half. In other words, each of the conductors 154 can have a semicircular columnar structure (hereinafter referred to as a “half-split via structure”) that is obtained by splitting a columnar via in half.

Similar to each of the conductors 154, each of the first signal pads 141C is a columnar conductor having a semicircular cross section (see FIG. 7). In other words, each of the first signal pads 141C can have the half-split via structure like each of the conductors 154.

As described above, the peripheral electrode 150C and the first signal pads 141C may each have the half-split via structure.

### <Modification 5>

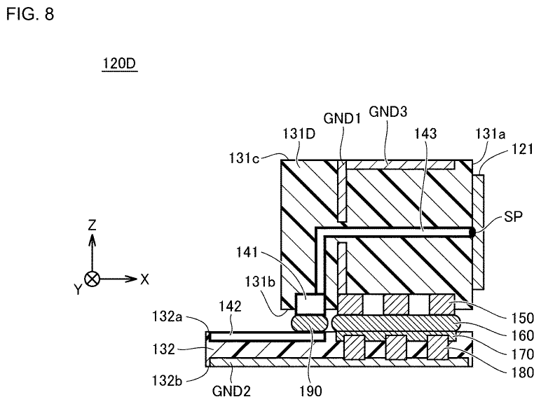

FIG. 8 is a diagram (side perspective view) partially illustrating the periphery of one of the radiating elements 121 in an antenna device 120D according to Modification 5.

The antenna device 120D according to Modification 5 is obtained by changing the first substrate 131 of the above-described antenna device 120 to a first substrate 131D. The first substrate 131D is obtained by adding a ground electrode GND3 to the above-described first substrate 131.

The ground electrode GND3 is disposed on or in a surface 131c of the first substrate 131D that is opposite to the opposing surface 131b. The ground electrode GND3 is formed on or in the surface 131c, in a region between the ground electrode GND1 and the radiating elements 121, and has a planar shape along the surface 131c. An end portion of the ground electrode GND3 in the negative X-axis direction is connected to the ground electrode GND1. An end portion of the ground electrode GND3 in the positive X-axis direction is not connected to the radiating elements 121.

By adding the ground electrode GND3 such as that described above, the width (resonant length, which is the size in the Z-axis direction in FIG. 8) of each of the radiating elements 121 can be further reduced.

The embodiments disclosed herein are to be considered in all respects as illustrative and not restrictive. The scope of the present invention is defined not by the description of the above embodiments, but by the claims, and it is intended that all equivalents to the claims and all modifications falling within the scope of the claims be included.

The above-described embodiments and their variations will be understood by those skilled in the art as specific examples of the following aspects.
(Item 1) An antenna device according to the present disclosure includes a first substrate and a second substrate having a first main surface facing the first substrate and a second main surface opposite to the first main surface. The first substrate includes a first ground electrode having a flat plate-like shape and a radiating element having a flat plate-like shape, the first ground electrode and the radiating element being arranged to face each other in a direction intersecting a direction normal to the second substrate, and a peripheral electrode disposed on or in an opposing surface being a surface facing the second substrate, the peripheral electrode being electrically connected to the first ground electrode. The second substrate includes a second ground electrode disposed on or in the second main surface or between the second main surface and the first main surface, the second ground electrode having a flat plate-like shape and extending along the second main surface and a ground pad disposed on or in the first main surface and electrically connected to the second ground electrode. The peripheral electrode and the ground pad are connected to each other through a connecting member having electrical conductivity.
(Item 2) In the antenna device according to Item 1, when the first substrate is viewed from a direction normal to the radiating element, a distance from a center of the radiating element to an end portion of the peripheral electrode is smaller than a dimension of the radiating element in a direction normal to the second substrate.
(Item 3) In the antenna device according to Item 1 or 2, the ground pad is disposed on or in the first main surface, at a position facing the peripheral electrode. The peripheral electrode and the ground pad are connected to each other through the connecting member while the peripheral electrode and the ground pad face each other.
(Item 4) In the antenna device according to any one of Items 1 to 3, when the peripheral electrode is viewed from a direction normal to the opposing surface, the peripheral electrode is a single electrode as a whole and includes a gap portion in or on which no electrode is formed, the gap portion being located within a region enclosed by an outer edge of the peripheral electrode.
(Item 5) In the antenna device according to Item 4, when the peripheral electrode is viewed from a direction normal to the opposing surface, the peripheral electrode has a lattice shape in which portions in or on which electrodes are formed and gap portions in or on which no electrodes are formed are alternately arranged.
(Item 6) The antenna device according to any one of Items 1 to 5 further includes a first feed wiring line disposed in such a manner as to extend across the first substrate and the second substrate and configured to supply a radio frequency signal to the radiating element. The first feed wiring line includes a first signal pad disposed on or in the opposing surface of the first substrate and a second signal pad disposed on or in the first main surface of the second substrate and connected to the first signal pad. The first signal pad is disposed on or in the opposing surface of the first substrate, in a region located opposite to the peripheral electrode, with the first ground electrode interposed between the region and the peripheral electrode.
(Item 7) The antenna device according to Item 6 further includes a second feed wiring line disposed in such a manner as to extend across the first substrate and the second substrate and configured to supply a radio frequency signal to the radiating element. The second feed wiring line further includes a third signal pad disposed on or in the opposing surface of the first substrate and a fourth signal pad disposed on or in the first main surface of the second substrate and connected to the third signal pad. The third signal pad is disposed on or in the opposing surface of the first substrate, in a region located opposite to the peripheral electrode, with the first ground electrode interposed between the region and the peripheral electrode.
(Item 8) The antenna device according to Item 7 further includes a member disposed on or in the first substrate, in a region between the first signal pad and the third signal pad, the member being connected to the peripheral electrode.
(Item 9) In the antenna device according to any one of Items 1 to 8, the first substrate is a multilayer body having a lamination direction parallel to a direction normal to the radiating element.
(Item 10) In the antenna device according to any one of Items 1 to 8, the first substrate is a multilayer body having a lamination direction parallel to a direction in which the radiating element extends.
(Item 11) In the antenna device according to any one of Items 1 to 10, a plurality of combinations of the first substrate and the ground pad are arranged along the first main surface of the second substrate.
(Item 12) A communication device according to the present disclosure is equipped with the antenna device according to any one of Items 1 to 11.

### REFERENCE SIGNS LIST

10 communication device
100 antenna module
111A to 113D, 117 switch
112AR to 112DR low-noise amplifier
112AT to 112DT power amplifier
114A to 114D attenuator
115A to 115D phase shifter
116 combiner/divider
118 mixer
119 amplifier circuit
120, 120A to 120D antenna device
121 radiating element
130 dielectric substrate
131, 131C, 131D first substrate
131a mounting surface
131b opposing surface
131c surface
132 second substrate
132a first main surface
132b second main surface
140, 140A feed wiring line
141, 141C first signal pad
141A third signal pad
142 second signal pad
142A fourth signal pad
143, 143A feed line
150, 150B, 150C peripheral electrode
151, 151B gap portion
152 outer edge
153 grounding member
154 to 156 conductor
160, 190 solder paste
170 ground pad
180 via
GND1, GND2, GND3 ground electrode
SP1, SP2 feed point

1. An antenna device comprising:
a first substrate; and
a second substrate having a first main surface facing the first substrate and a second main surface opposite to the first main surface,
wherein the first substrate includes
a first ground electrode having a flat plate-like shape and a radiating element having a flat plate-like shape, the first ground electrode and the radiating element being arranged to face each other in a direction intersecting a direction normal to the second substrate, and
a peripheral electrode disposed on or in an opposing surface of the first substrate being a surface facing the second substrate, the peripheral electrode being electrically connected to the first ground electrode,
wherein the second substrate includes
a second ground electrode disposed on or in the second main surface or between the second main surface and the first main surface, the second ground electrode having a flat plate-like shape and extending along the second main surface, and
a ground pad disposed on or in the first main surface and electrically connected to the second ground electrode, and
wherein the peripheral electrode and the ground pad are electrically connected to each other.

2. The antenna device according to claim 1,
wherein, when the first substrate is viewed from a direction normal to the radiating element, a distance from a center of the radiating element to an end portion of the peripheral electrode is smaller than a dimension of the radiating element in a direction normal to the second substrate.

3. The antenna device according to claim 1,
wherein the ground pad is disposed on or in the first main surface, at a position facing the peripheral electrode, and
wherein the peripheral electrode and the ground pad are connected to each other through the connecting member while the peripheral electrode and the ground pad face each other.

4. The antenna device according to claim 1,
wherein, when the peripheral electrode is viewed from a direction normal to the opposing surface, the peripheral electrode is a single electrode as a whole and includes a gap portion in or on which no electrode is formed, the gap portion being located within a region enclosed by an outer edge of the peripheral electrode.

5. The antenna device according to claim 4,
wherein, when the peripheral electrode is viewed from a direction normal to the opposing surface, the peripheral electrode has a lattice shape in which portions in or on which electrodes are formed and gap portions in or on which no electrodes are formed are alternately arranged.

6. The antenna device according to claim 5,
wherein the lattice shape comprises a plurality of substantially rectangular gap portions.

7. The antenna device according to claim 1, further comprising:
a first feed wiring line disposed in such a manner as to extend across the first substrate and the second substrate and configured to supply a radio frequency signal to the radiating element,
wherein the first feed wiring line includes
a first signal pad disposed on or in the opposing surface of the first substrate, and
a second signal pad disposed on or in the first main surface of the second substrate and connected to the first signal pad, and
wherein the first signal pad is disposed on or in the opposing surface of the first substrate, in a region located opposite to the peripheral electrode, with the first ground electrode interposed between the region and the peripheral electrode.

8. The antenna device according to claim 7, further comprising:
a second feed wiring line disposed in such a manner as to extend across the first substrate and the second substrate and configured to supply a radio frequency signal to the radiating element,
wherein the second feed wiring line further includes
a third signal pad disposed on or in the opposing surface of the first substrate, and
a fourth signal pad disposed on or in the first main surface of the second substrate and connected to the third signal pad, and
wherein the third signal pad is disposed on or in the opposing surface of the first substrate, in a region located opposite to the peripheral electrode, with the first ground electrode interposed between the region and the peripheral electrode.

9. The antenna device according to claim 8, further comprising:
a member disposed in a region between the first signal pad and the third signal pad when viewed from a direction normal to the second substrate, the member being connected to the peripheral electrode.

10. The antenna device according to claim 8,
wherein the first feed wiring line connects to a first feed point on the radiating element offset from a center of the radiating element in a first direction, and the second feed wiring line connects to a second feed point on the radiating element offset from the center in a second direction, the second direction being orthogonal to the first direction.

11. The antenna device according to claim 1,
wherein the first substrate is a multilayer body laminated in a direction normal to the radiating element.

12. The antenna device according to claim 1,
wherein the first substrate is a multilayer body having a lamination direction parallel to a direction in which the radiating element extends.

13. The antenna device according to claim 1,
wherein a plurality of combinations of the first substrate and the ground pad are arranged along the first main surface of the second substrate.

14. The antenna device according to claim 1, further comprising a third ground electrode disposed on a surface of the first substrate opposite the opposing surface, wherein the third ground electrode is connected to the first ground electrode and extends toward the radiating element.

15. The antenna device according to claim 1,
wherein at least one of the peripheral electrode and a signal pad on the opposing surface includes a conductor having a substantially semicircular cross-section.

16. The antenna device according to claim 1, further comprising solder electrically connecting the peripheral electrode and the ground pad.

17. A communication device equipped with the antenna device according to claim 1.

18. An antenna device, comprising:
a primary substrate having a primary ground electrode formed therein or thereon;
a dielectric body mounted on a main surface of the primary substrate such that a bottom surface of the dielectric body faces the main surface;
a radiating element disposed on or in a side surface of the dielectric body, the side surface being substantially perpendicular to the main surface of the primary substrate;
a secondary ground electrode disposed within the dielectric body and arranged to face the radiating element; and
a peripheral conductive structure disposed on the bottom surface of the dielectric body, wherein the peripheral conductive structure is electrically connected to the secondary ground electrode and is further electrically connected to the primary ground electrode of the primary substrate.
